(19) United States
(12) Patent Application Publication
(10) Pub. No.: US 2026/0235506 A1
(43) Pub. Date: Aug. 13, 2026

(54) SYSTEM AND METHOD OF ASSESSING A COATING MICROSTRUCTURE

(71) Applicant: General Electric Company, Evendale, OH (US)

(72) Inventors: Ayush Chauhan, Bangalore (IN); Esha Sen Gupta, Bengaluru (IN); Aditya Kulkarni, Bangalore (IN); Mohandas Nayak, Bengaluru (IN); Hrishikesh Keshavan, Syracuse, NY (US)

(21) Appl. No.: 19/292,115

(22) Filed: Aug. 6, 2025

(30) Foreign Application Priority Data
Feb. 12, 2025 (IN) 202511011825

(51) Int. Cl. G01N 21/3581; G01M 15/14; G01N 21/3563; G01N 21/84

(52) U.S. Cl. CPC G01N 21/3581; G01N 21/3563; G01N 21/8422; G01M 15/14; G01N 2021/8427; G01N 2201/0694; G01N 2201/0696

(57) ABSTRACT

A method for determining a microstructure of a coating on a component includes emitting an electromagnetic signal through a first polarizer and a second polarizer onto the coating, the electromagnetic signal having a frequency of at least 0.1 gigahertz (GHz), receiving a reflected electromagnetic signal from the coating, determining a waveform of the reflected electromagnetic signal, the waveform defining a plurality of peaks including a first peak and a second peak subsequent in time to the first peak, each of the plurality of peaks defined as a point where an amplitude of the waveform is greater than respective amplitudes of immediately adjacent points of the waveform, and determining a grain density of the microstructure of the coating based on the second peak of the waveform.

### PRIORITY INFORMATION

The present application claims priority to Indian Patent Application number 202511011825 filed on Feb. 12, 2025.

### FIELD

The present disclosure relates to a system and method for assessing a microstructure of a coating of a component.

### BACKGROUND

Some components, such as hot gas path components of gas turbines, are subjected to high temperatures while in service. At least some such components include a coating system, including a thermal barrier coating and bond coat, on an surface exposed to the high temperatures. The microstructure of many thermal barrier coatings is dependent on the process parameters of the coating application process. For example, thermal barrier coatings made of the same material may nevertheless have varying microstructures due to variations in the process parameters of the respective coating application processes. Some microstructures are more effective at protecting components from exposure to high temperatures, while other microstructures may have a comparatively reduced effectiveness and shorter service life. However, at least some known methods, such as destructive testing, for determining the microstructure of a particular coating are time-consuming and expensive to implement.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic view of a system for characterizing a microstructure of a coating of a component.

FIG. 2 is a side cross-sectional view of an exemplary component.

FIG. 3 is a chart of a waveform of an electromagnetic signal reflected from the coating.

FIG. 4 is a chart of normalized peak widths of a plurality of waveforms.

FIG. 5 is a diagram of exemplary microstructures of coatings.

FIG. 6 is a schematic view of an exemplary coating divided into a plurality of areas.

FIG. 7 is a diagram of an exemplary controller.

FIG. 8 is a block diagram of an exemplary method for determining a microstructure of a coating.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The phrases “from X to Y” and “between X and Y” each refers to a range of values inclusive of the endpoints (i.e., refers to a range of values that includes both X and Y).

As used herein, the terms “first,” “second,” “third,” and other ordinals are used to distinguish one component from another and are not intended to signify location or importance of the individual components.

As used herein, ceramic matrix composite or “CMCs” refers to composites comprising a ceramic matrix reinforced by ceramic fibers. Some examples of CMCs acceptable for use herein can include, but are not limited to, materials having a matrix and reinforcing fibers comprising oxides, carbides, nitrides, oxycarbides, oxynitrides and mixtures thereof. Examples of non-oxide materials include, but are not limited to, CMCs with a silicon carbide matrix and silicon carbide fiber (when made by silicon melt infiltration, this matrix will contain residual free silicon); silicon carbide/silicon matrix mixture and silicon carbide fiber; silicon nitride matrix and silicon carbide fiber; and silicon carbide/silicon nitride matrix mixture and silicon carbide fiber. Furthermore, CMCs can have a matrix and reinforcing fibers comprised of oxide ceramics. Specifically, the oxide-oxide CMCs may be comprised of a matrix and reinforcing fibers comprising oxide-based materials such as aluminum oxide (Al2O3), (silicon dioxide (SiO2), aluminosilicates, and mixtures thereof. Accordingly, as used herein, the term “ceramic matrix composite” includes, but is not limited to, carbon-fiber-reinforced carbon (C/C), carbon-fiber-reinforced silicon carbide (C/SiC), and silicon-carbide-fiber-reinforced silicon carbide (SiC/SiC). In one embodiment, the ceramic matrix composite material has increased elongation, fracture toughness, thermal shock, and anisotropic properties as compared to a (non-reinforced) monolithic ceramic structure.

As used herein, the term “plane of polarization” refers to a plane containing the propagation direction of the electromagnetic wave and, for example, the electric vector. For linearly polarized light, the plane of polarization can be along the direction of propagation, along which the electric field vector (or magnetic field vector) is confined.

As used herein, the term “axis of a polarizer” or “axis of a polarizing filter” is the direction of the slits of the polarizer. Polarizers or polarizing filters with linear axes can provide linearly polarized light.

A “grain density” is a number of grains per unit area, such as the number of grains per 1000 square micrometers.

As used herein, an environmental barrier coating or “EBC” refers to a coating system comprising one or more layers of ceramic materials, each of which provides specific or multi-functional protections to the underlying CMC. EBCs generally include a plurality of layers, such as rare earth silicate coatings (e.g., rare earth disilicates such as slurry or APS-deposited yttrium ytterbium disilicate (YbYDS)), alkaline earth aluminosilicates (e.g., comprising barium-strontium-aluminum silicate (BSAS), such as having a range of BaO, SrO, Al₂O₃, and/or SiO₂ compositions), hermetic layers (e.g., a rare earth disilicate), and/or outer coatings (e.g., comprising a rare earth monosilicate, such as slurry or APS-deposited yttrium monosilicate (YMS)). One or more layers may be doped as desired, and the EBC may also be coated with an abradable coating.

As used here, a thermal barrier coating or “TBC” refers to a coating that resists thermal expansion and thermal stresses. Ceramic materials and particularly yttria-stabilized zirconia (YSZ) are widely used as TBC materials because of their high temperature capability, low thermal conductivity, and relative ease of deposition by plasma spraying, flame spraying and physical vapor deposition (PVD) techniques. Plasma spraying processes such as air plasma spraying (APS) yield noncolumnar coatings characterized by a degree of inhomogeneity and porosity, and have the advantages of relatively low equipment costs and ease of application. TBC's employed in the highest temperature regions of gas turbine engines are often deposited by PVD, particularly electron-beam PVD (EBPVD), which yields a strain-tolerant columnar grain structure. Similar columnar microstructures with a degree of porosity can be produced using other atomic and molecular vapor processes.

The present disclosure is generally related to determining a microstructure of a coating of a component, such as an EBC or a TBC. Traditionally, microstructures of coatings, such as thermal barrier coatings applied to one or more substrates of a turbine engine parts, are inspected by destructive analysis. The destructive analysis includes at least cutting the coating of a sample taken from a group of components. The cut allows an area of interest to be polished and inspected. The inspected part becomes scrap and, based on the results of the destructive inspection, the remainder of the parts in the group move forward in production or are rejected. This process can take about 24-48 hours and includes a loss of one or more parts.

By using polarized terahertz (THz) range electromagnetic signals, the microstructure of the coating can be determined in a non-destructive manner. In particular, peak values of pulsed THz signals correlate to the grain density of the coating, and collecting data from the coatings with THz signals is faster than using other methods. The detection and analysis of the refracted and reflected electromagnetic pulses at the different polarization angles provide information from which the microstructure of the coating can be determined. By characterizing the grain structure of the coating, mechanical properties and strategies for calcium-magnesia,alumina-silicate (CMAS) mitigation of the coating can be determined, improving quality control and process development for coated components, such as coated CMC components for an aircraft engine.

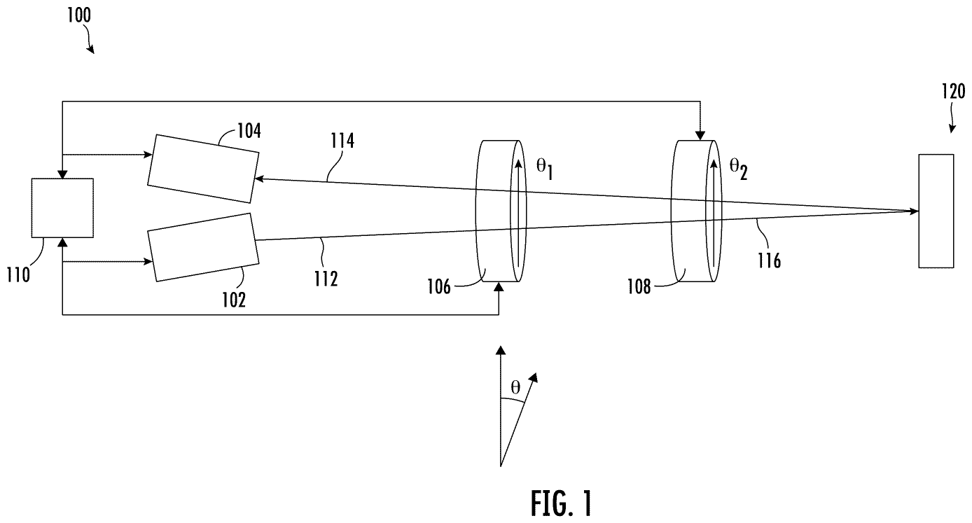

Referring now to the drawings, wherein identical numerals indicate the same elements throughout the figures, FIG. 1 is a schematic view of a system 100 for characterizing a microstructure of a component is provided. The system 100 includes an electromagnetic (EM) radiation emitter 102, an EM radiation detector 104, a first polarizer 106, a second polarizer 108, and a controller 110. The system 100 is configured to characterize the microstructure of a component 120, such as a ceramic matrix composite (CMC) component or a metal component. Specifically, the system 100 uses EM signals in a terahertz (THz) frequency range to determine a grain density of the coating of the component 120.

The EM radiation emitter 102 emits an EM signal 112. Specifically, the EM radiation emitter 102 emits a plurality of EM pulses in a specific frequency range that defines the EM signal 112. The frequency range includes frequencies that, when reflected from the microstructure of the coating, correlate to the grain density of the coating. The frequency range may be from 0.1 gigahertz (GHz) to 10 terahertz (THz), preferably from 0.1 THz to 10 THz. Increasing the frequency of the EM signal 112 may result in an increase in spatial resolution, providing improved accuracy and precision in determining the microstructure of the coating. The EM radiation emitter 102 is illustrated as a single source, and it will be appreciated that any number of sources that provide EM radiation are contemplated. The EM radiation emitter 102 provides the EM signal 112 having an oscillating electric field confined to a single plane of polarization along the direction of propagation, i.e., linearly polarized electromagnetic radiation. In some embodiments, the EM radiation emitter 102 may be unpolarized and the EM signal is polarized by the polarizer 106. In some embodiments, the EM radiation emitter 102 may include an unpolarized EM source and an integrated polarizer.

The first polarizer 106 is a structure that is rotatable about an axis of polarization that polarizes the EM signal to a specified polarization angle. The specified polarization angle is a first polarization angle θ₁, defined relative to a reference axis, such as the plane of polarization of the EM radiation emitter 102. The first polarizer 106 is disposed between the EM radiation emitter 102 the component 120 being inspected. While illustrated as spaced from the EM radiation emitter 102, it is appreciated that the first polarizer 106 may be coupled to or included in the EM radiation emitter 102.

The first polarization angle θ₁ of the first polarizer 106 is rotatable to direct the EM signal to the second polarizer 108 in a specified orientation. As an example, the first polarizer 106 may have a first polarization angle θ₁ of 0 degrees. Alternatively, as another example, the first polarizer 106 may have a first polarization angle θ₁ of 45 degrees. It will be appreciated that the first polarization angle θ₁ may be a different value from 0 to 90 degrees relative to the plane of polarization of the EM radiation emitter 102.

The second polarizer 108 is a structure that polarizes the EM signal 112 from the first polarizer 106 to a second polarization angle θ₂. The second polarizer 108 is disposed between the first polarizer 106 and the component 120. While illustrated as spaced from the EM radiation emitter 102, it is appreciated that the second polarizer 108 may be coupled to or included in the EM radiation emitter 102 forward of the first polarizer 106. In some embodiments, the second polarizer 108 may be omitted and the polarization angles may be changed based on the rotation of the first polarizer 106 alone.

The second polarizer 108 defines the second polarization angle θ₂ in a range from −90 degrees to 90 degrees relative to the first polarization angle θ₁. More specifically, the second polarizer 108 is rotatable to one or more different second polarization angles θ₂ to provide a polarized EM signal 116 to the component 120 at different orientations. The polarized EM signal 116 is polarized to the combined effect of the first polarization angle θ₁ and the second polarization angle θ₂. Because any individual polarizer has a polarization angle range that is less than a full 360-degree circle, by using two polarizers 106, 108, more polarization angles for the EM signal 112 are available. That is, when the polarization angle is close to 90 degrees away from the axis of the EM signal 112, the amplitude of the EM signal 112 drops close to noise levels. By using two polarizers 106, 108, the overall amplitude of the polarized EM signal 116 drops less than a single polarizer at the same effective polarization angle, increasing a total range of polarization angles for the polarized EM signal 116. As described further in detail below, by providing different orientations of the polarized EM signal 116, the microstructure of the component 120 may be more precisely characterized.

The EM radiation detector 104 receives the reflected EM signal 114 from the component 120. Specifically, as the polarized EM signal 116 is reflected from the microstructure of the component 120, the EM radiation detector 104 collects data indicating an amplitude and a time at which the pulses of the reflected EM signal 114 reach sensors (not shown) of the EM radiation detector 104. The EM radiation detector 104 is arranged such that the reflected EM signal 114 passes through the second polarizer 108 and the first polarizer 106 from the component 120 prior to reaching the EM radiation detector 104.

The controller 110 is in communication with the EM radiation emitter 102, the EM radiation detector 104, the first polarizer 106, and the second polarizer 108. The controller 110 includes a processor and a memory, described in further detail below, that provide instructions to actuate components of the system 100. As an example, the controller 110 instructs the EM radiation emitter 102 to emit the EM signal 112 at a specified frequency. Then, the controller 110 instructs the EM radiation detector 104 to collect data regarding the reflected EM signal 114 and transmit the collected data to the memory. The controller 110 is further configured to rotate the first polarizer 106 and the second polarizer 108 to specified polarization angles θ₁, θ₂ to provide a specified plane of polarization for the polarized EM signal 116.

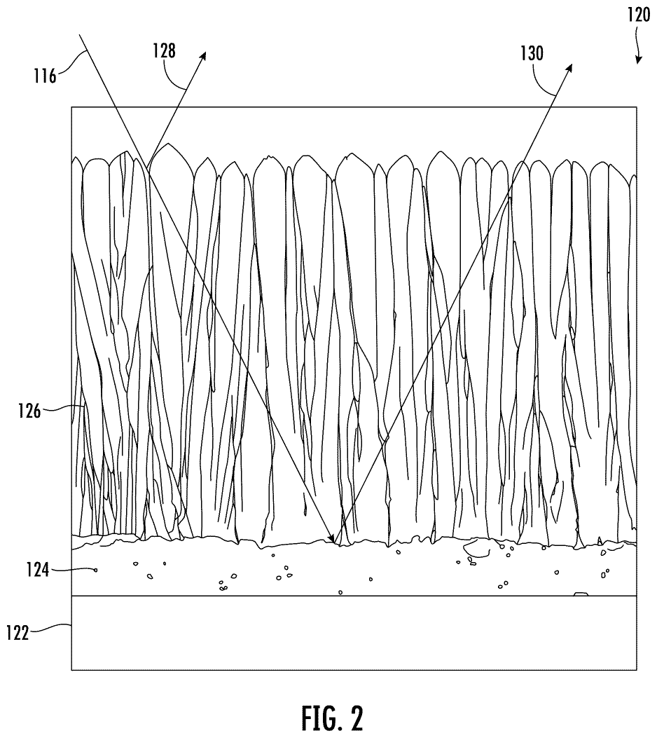

Now referring to FIG. 2, a cross-sectional view of a component 120 is shown. The component 120 includes a substrate 122, a bond coat 124, and a coating 126. The substrate 122 is a suitable material, such as metal or CMC. The bond coat 124 is disposed beneath the coating 126 and adheres the coating 126 to the substrate 122. The coating 126 is one of a TBC or an EBC, as defined above.

The polarized EM signal 116 reflects at least partially from both the coating 126 and the bond coat 124. More specifically, the polarized EM signal 116 travels toward the component 120, and a first portion of the polarized EM signal 116 reflects from the coating 126, forming a first reflected EM signal 128. The remainder of the polarized EM signal 116 travels through the coating 126 and reflects from the bond coat 124, forming a second reflected EM signal 130. The EM radiation emitter 102 receives the first reflected EM signal 128 prior in time to receiving the second reflected EM signal 130, indicated as two peaks of amplitude data, as described in further detail below. Based on the second reflected EM signal 130, the controller 110 can characterize properties of the microstructure of the coating 126, such as grain density. While the second peak is generally described as being associated with the EM signal reflected off of the bond coat 124, when the component 120 being inspected is formed of a coating 126 deposited directly on the substrate 122, the second peak may be associated with the EM signal reflected off of the substrate 122.

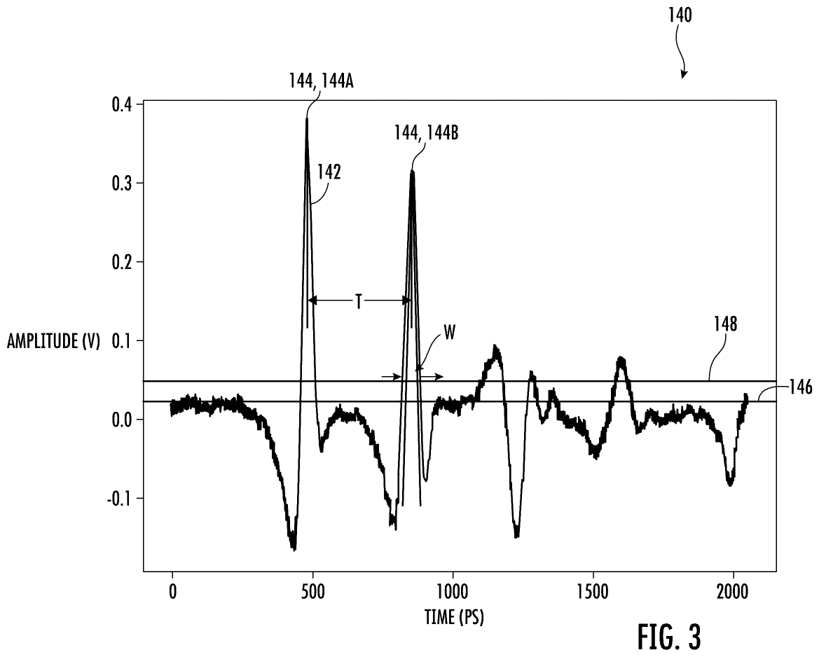

With reference to FIG. 3, a plot 140 of a waveform 142 of a reflected EM signal 114 is provided. The waveform 142 is a graph indicating an amplitude of the reflected EM signal 114 at a specific time, measured from a reference time, such as the time of the emission of the EM signal 112. The plot 140 has amplitude in voltage (V) on the vertical axis and time in picoseconds (10⁻¹² seconds) on the horizontal axis. The controller 110 determines the waveform 142 based on data collected from the EM radiation detector 104.

The waveform 142 defines a plurality of peaks 144. In this context, a “peak” is a point where an amplitude of the waveform 142 is greater than respective amplitudes of immediately adjacent points of the waveform 142. To reduce the amount of identified peaks 144, the controller 110 can determine the peaks 144 that have respective amplitudes above a specified amplitude threshold 146, such as an absolute value of 0.2, a relative value of 10% of the height of one of the peaks 144, or other values. That is, the peaks are local maxima of the amplitudes that are above the amplitude threshold 146. Additionally, the waveform 142 may undergo a smoothing operation to remove peaks caused by measurement tolerances, leaving only peaks representing a true local maximum of amplitude. By only considering peaks above the amplitude threshold 146, local peaks caused by noise are removed from consideration, and only peaks from the reflected EM signal 114 reflected from the component 120 are considered.

The waveform 142 includes a first peak 144A and a second peak 144B. The first peak 144A is a highest one of the plurality of peaks 144, and the second peak 144B is a second-highest one of the plurality of peaks 144. Alternatively, the first peak 144A is a peak 144 above the amplitude threshold 146 with an earliest time, and the second peak 144B is the next peak 144 above the amplitude threshold 146. In either form, the second peak 144B is subsequent in time to the first peak 144A. In particular, the amplitude threshold 146 may be determined by the height of the second peak 144B from the horizontal axis (i.e., an amplitude of 0), such as 10% of the height of the second peak 144B, to remove peaks resulting from noise. The first peak 144A of the waveform 142 indicates when the first reflected EM signal 128 (FIG. 2) that reflected from the coating 126 reaches the EM radiation detector 104, and the second peak 144B indicates when the second reflected EM signal 130 (FIG. 2) that reflected from the bond coat 124 reaches the EM radiation detector 104.

The controller 110 can determine a width W of the waveform 142 around the second peak 144B. In this context, the width W is a time interval from a first time at which a first value of the amplitude of the waveform 142 exceeds a second amplitude threshold 148 (such as 10% of the height of the first peak 144A from the horizontal axis) prior to the second peak 144B to a second time at which a second value of the waveform 142 exceeds the second amplitude threshold 148 after the second peak 144B. That is, the width W represents the time interval when the second reflected EM signal 130 reflected from the bond coat 124 is detected by the EM radiation detector 104. The second amplitude threshold 148 is typically different than the amplitude threshold 146, but it will be appreciated that the second amplitude threshold 148 and the amplitude threshold 146 may be a same value.

The controller 110 can determine a normalized peak width Wₙ based on the determined width W. Because of variations in thickness of the coating 126, the time and width of the second peak may vary. To consider a common metric for coatings 126 of different thicknesses, the controller 110 can normalize values for the width of the second peak based on the thickness of the coating 126. To determine the thickness of the coating 126, the controller 110 determines a time interval between the first peak 144A and the second peak 144B. The time interval indicates a time for a portion of the EM signal to travel through the coating 126, reflect from the bond coat, and exit the coating 126 to the EM radiation detector 104. The time interval between the first and second peaks 144A, 144B thus correlates to twice the thickness of the coating 126, and the controller 110 can determine the normalized peak width Wₙ according to the following expression:

$${W}_{n} = \frac{2 {Wn}_{s}}{cT cos Θ} \qquad ( 1 )$$

where T is the time interval between the first and second peaks 144A, 144B, W is the width of the waveform 142 around the second peak 144B, c is the speed of light in a vacuum, nₛ is the refractive index of the coating 126, and Θ is the sum of the first and second polarization angles θ₁, θ₂.

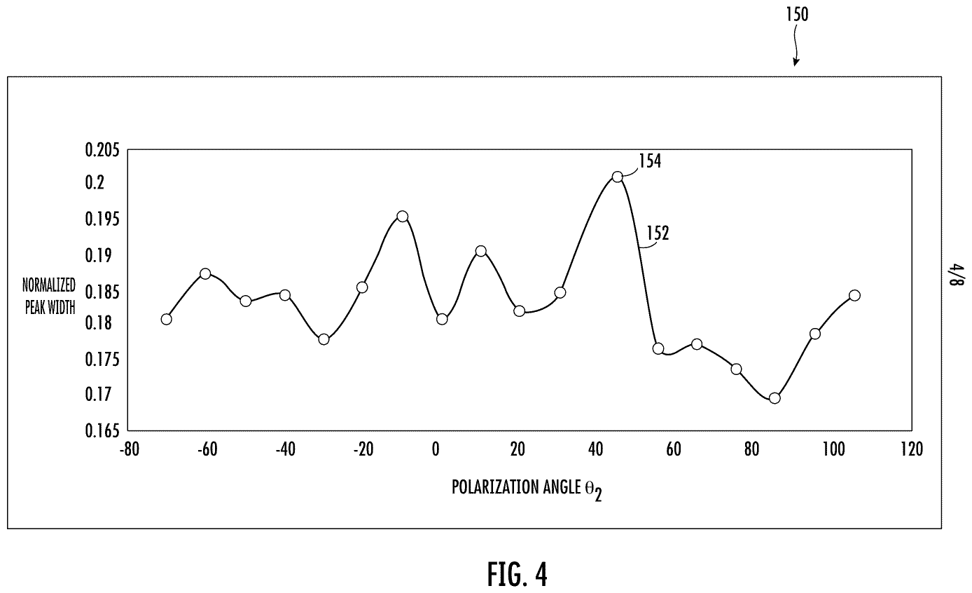

Now referring to FIG. 4, a plot 150 of normalized peak widths Wₙ is provided. Specifically, the plot 150 shows a graph 152 indicating a value of the normalized peak width Wₙ for different second polarization angles θ₂. The vertical axis is the normalized peak width Wₙ, which is unitless, and the horizontal axis is the second polarization angle θ₂, in degrees relative to a reference axis, as described above.

To determine a maximum normalized peak width 154, the controller 110 rotates the second polarizer 108 to a plurality of second polarization angles θ₂ and instructs the EM radiation emitter 102 to emit an EM signal 112 upon reaching each of the plurality of second polarization angles θ₂. Then, the EM radiation detector 104 receives a respective reflected EM signal 114 from each respective emitted EM signal 112, and the controller 110 determines a respective waveform 142 for each respective reflected EM signal 114 to form a plurality of waveforms 142. Each of the plurality of waveforms 142 defines a first peak 144A (FIG. 3) and a second peak 144B (FIG. 3) subsequent in time to the first peak 144A, such that the plurality of waveforms 142 define a plurality of second peaks 144B. The controller 110 determines a respective normalized peak width Wₙ for each of the second peaks 144B to form a plurality of normalized peak widths Wₙ. Because the bond coat 124 may reflect the polarized EM signal 116 (FIG. 2) differently based on the angle at which the polarized EM signal 116 reaches the bond coat 124, using a plurality of second polarization angles θ₂ allows the controller 110 to determine a maximum normalized peak width 154, i.e., an orientation for the polarized EM signal 116 at which a largest portion of the polarized EM signal 116 is reflected from the bond coat 124 and received by the EM radiation detector 104. As described in further detail below, the maximum normalized peak width 154 is correlated with the grain density of the microstructure of the coating 126.

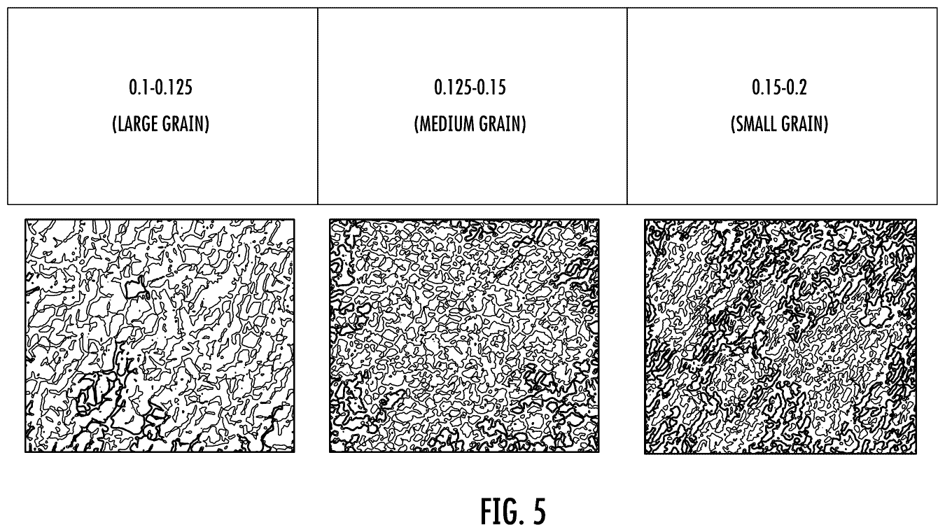

With reference to FIG. 5, schematic views of microstructures having different grain densities are shown. The controller 110 determines a grain density of the microstructure of the coating 126 based on the maximum normalized peak width Wₙ, defined above based on the second peak 144B of the waveform 142 and the thickness of the coating 126. The controller 110 can determine the grain density by comparing the normalized peak width Wy to a lookup table. For example, as shown in FIG. 5, the lookup table can include categories of grain density, such as “large grain,” “medium grain” and “small grain,” indicating increasing grain density for the coating 126. As an example, the “large grain” category refers to a grain density of less than 5 grains per 1000 square microns, the “medium grain” category refers to a grain density in a range from 5 to 15 grains per 1000 square microns, and the “small grain” category refers to a grain density in a range greater than 15 grains per 1000 square microns.

Each category is defined by a range of normalized peak widths, such as 0.100-0.125 for “large grain,” 0.125-0.150 for “medium grain,” and 0.150-0.200 for “small grain.” Alternatively, the controller 110 can determine a numerical value for the grain density d with a regression model that is based on empirical testing (such as destructive or nondestructive testing) of sample coatings 126:

$$d = {AW}_{n} + B \qquad ( 2 )$$

where A, B are empirically determined constants, and the grain density d has units of number of grains per 1000 square microns. Example values for A, B are A=5.80, B=1.88. The controller 110 can determine the grain density d based on a specific one of the normalized peak widths Wₙ, such as a largest normalized peak width, a median normalized peak width, or a mean normalized peak width.

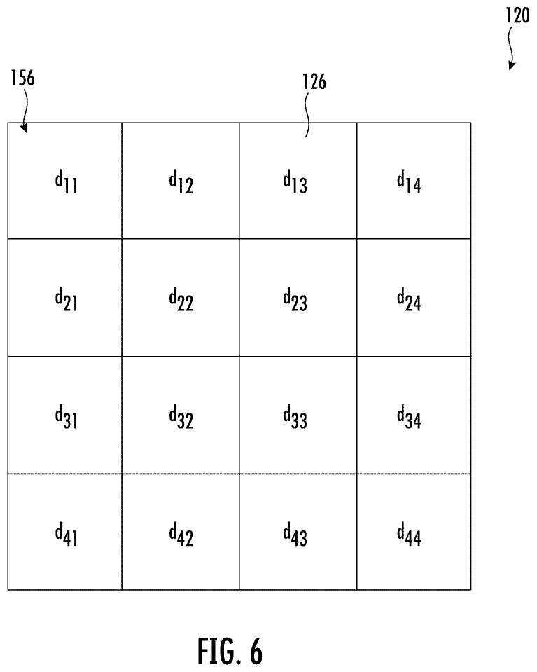

With reference to FIG. 6, an exemplary grid on a coating 126 of a component 120 is provided. The coating 126 is divided into a plurality of areas 156, sixteen of which are shown in FIG. 6. Each area 156 has a specific grain density defined by the local microstructure. To characterize the microstructure of the coating 126, the controller 110 actuates the EM radiation emitter 102 to emit an EM signal 112 onto each area 156 and receives a respective reflected EM signal 114 from each area 156 with the EM radiation detector 104. Then, the controller 110 determines a respective waveform 142 for each reflected EM signal and determines a respective grain density d for each area 156. In FIG. 6, the resulting plurality of grain densities are marked according to the position of each area 156 in a grid, with d₁₁ being the grain density in the area 156 of the first row and the first column, d₁₂ being the grain density in the area 156 of the first row and the second column, and so on. The controller 110 selects one of the grain densities d as the overall grain density of the coating 126 based on one or more selection criteria. As an example, the controller 110 can determine an arithmetic mean d̅ of each of the grain densities d and select the arithmetic mean d̅ as the overall grain density of the coating 126. The arithmetic mean is calculated according to the conventional definition in statistics, as the sum of all of the grain densities d divided by the number of grain densities, which is 16 in FIG. 6.

As another example, the controller 110 can determine a median grain density d_{median}, which is a value where half of the grain densities d are above the median grain density d_{median} and half of the grain densities d are below the median grain density d_{median}, i.e., the conventional definition of “median” in statistics.” The controller 110 can select the median grain density d_{median} as the overall grain density of the coating 126. It will be appreciated that the median grain density d_{median} may be determined after removing outlier values from the plurality of grain densities d, where the “outliers” are determined based on a conventional statistical metric, such as more than 2 standard deviations from a mean d̅.

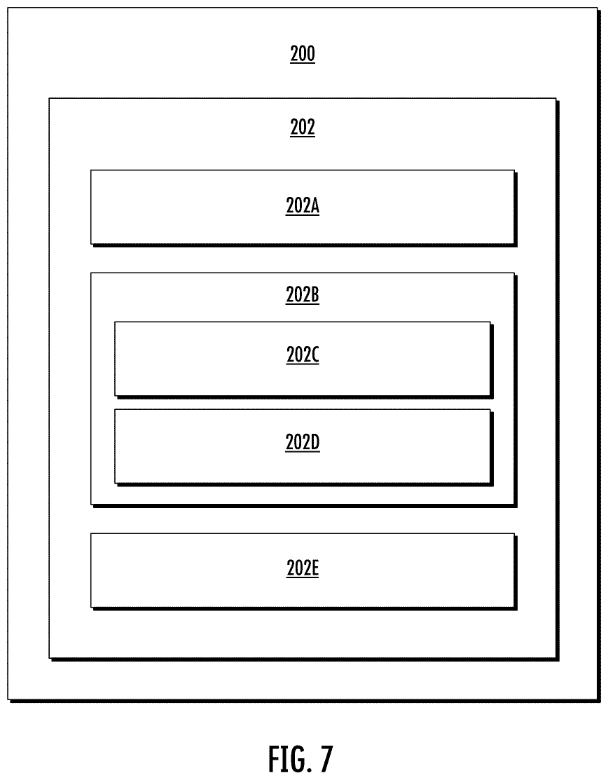

Now referring to FIG. 7, a block diagram showing the operation of an exemplary controller 200, such as the controller 110, which may be used to control one or more components of the system of FIG. 1, will be described. In at least certain embodiments, the controller 200 can include one or more computing devices 202. The computing devices 202 can include one or more processors 202A and one or more memory devices 202B. The one or more processors 202A can include any suitable processing device, such as a microprocessor, microcontroller, integrated circuit, logic device, or other suitable processing device. The one or more memory devices 202B can include one or more computer-readable media, including, but not limited to, non-transitory computer-readable media, RAM, ROM, hard drives, flash drives, or other memory devices.

The one or more memory devices 202B can store information accessible by the one or more processors 202A, including computer-readable instructions 202C that can be executed by the one or more processors 202A. The instructions 202C can be any set of instructions that when executed by the one or more processors 202A, cause the one or more processors 202A to perform operations. In some embodiments, the instructions 202C can be executed by the one or more processors 202A to cause the one or more processors 202A to perform operations, such as any of the operations and functions for which the controller 200 or the computing devices 202 are configured. The instructions 202C can be software written in any suitable programming language or can be implemented in hardware. Additionally or alternatively, the instructions 202C can be executed in logically or virtually separate threads on the one or more processors 202A. The one or more memory devices 202B can further store data 202D that can be accessed by the one or more processors 202A.

The computing devices 202 can also include a network interface 202E used to communicate, for example, with one or more networks. The network interface 202E can include any suitable components for interfacing with the one or more networks, including for example, transmitters, receivers, ports, controllers, antennas, or other suitable components.

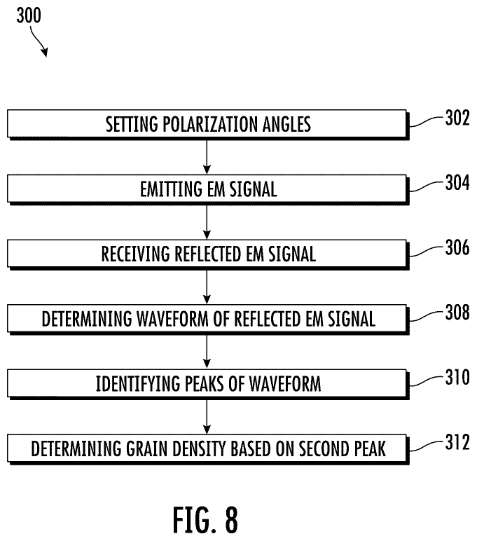

Referring now to FIG. 8, a flow diagram of a method 300 of determining a microstructure of a coating on a component is provided. The method 300 may be utilized by the controller 200 of FIG. 7 to determine the microstructure of the coating for a component as described above with reference to FIG. 1-6.

As is depicted, the method 300 includes at (302) setting respective polarization angles for a first polarizer and a second polarizer. As described above, a controller rotates the first polarizer to a first polarization angle and the second polarizer to a second polarization angle. The first and second polarization angles are determined to provide a specific orientation for an EM signal.

The method 300 includes at (304) emitting an EM signal. As described above, an EM radiation emitter emits a series of electromagnetic pulses at a specified frequency toward the CMC component. The specified frequency is in a terahertz frequency range, such as from 0.01 THz to 10 THz. The EM signal emitted by the EM radiation emitter is polarized by the first and second polarizers to a specific polarization angle.

The method 300 includes at (306) receiving a reflected EM signal from the CMC component. The EM signal reflects from different parts of the CMC component, including a portion that reflects from the coating and another portion that reflects from the bond coat. An EM radiation detector includes one or more sensors that receive the reflected EM signal.

The method 300 includes at (308) determining a waveform of the reflected EM signal. A controller receives data from the EM radiation detector indicating amplitudes of the received reflected EM signal at specific times. The controller plots the amplitude data as a function of the times, generating the waveform of the reflected EM signal.

The method 300 includes at (310) identifying peaks of the waveform. As described above, the peaks of the waveform are local maxima that are above a specified amplitude threshold. In particular, a first peak corresponds to the portion of the emitted EM signal that reflected from the coating, and a second peak corresponds to the portion of the emitted EM signal that reflected from the bond coat.

The method 300 includes at (312) determining the grain density of the microstructure of the coating based on the second peak. Specifically, as described above, the controller determines a normalized peak width of the second peak based on a thickness of the coating and a measured width of the second peak. The controller then determines the grain density based on the normalized peak width, either as a qualitative category such as “large grain” or “small grain,” or as an estimated number of grains per unit area of the coating. Additionally, the controller can determine respective normalized peak widths for a plurality of waveforms, each waveform corresponding to an emitted EM signal at a specific polarization angle, and the controller can determine the grain density based on a specific one of the normalized peak widths, such as a largest normalized peak width, a median normalized peak width, or a mean normalized peak width.

Further aspects are provided by the subject matter of the following clauses:

A method for determining a microstructure of a coating on a component, the method including emitting an electromagnetic signal through a polarizer onto the coating, the electromagnetic signal having a frequency of at least 0.1 gigahertz (GHz), receiving a reflected electromagnetic signal from the coating, determining a waveform of the reflected electromagnetic signal, the waveform defining a plurality of peaks including a first peak and a second peak subsequent in time to the first peak, each of the plurality of peaks defined as a point where an amplitude of the waveform is greater than respective amplitudes of immediately adjacent points of the waveform, and determining a grain density of the microstructure of the coating based on the second peak of the waveform.

The method of any of the preceding clauses, wherein the polarizer is a first polarizer, the first polarizer has a first polarization angle of 0 degrees relative to a reference axis, and wherein a second polarizer has a second polarization angle in a range from −90 degrees to 90 degrees relative to the first polarization angle.

The method of any of the preceding clauses, wherein the polarizer is a first polarizer, the first polarizer has a first polarization angle of 45 degrees relative to a reference axis, and wherein a second polarizer has a second polarization angle in a range from −90 degrees to 90 degrees relative to the first polarization angle.

The method of any of the preceding clauses, wherein the coating is one of a thermal barrier coating or an environmental barrier coating.

The method of any of the preceding clauses, wherein the reflected electromagnetic signal is at least partially reflected from a bond coat disposed beneath the coating.

The method of any of the preceding clauses, further including rotating the polarizer to a plurality of polarization angles, emitting a respective electromagnetic signal at each of the plurality of polarization angles, receiving a respective reflected electromagnetic signal from each respective emitted electromagnetic signal, determining a respective waveform for each respective reflected electromagnetic signal to form a plurality of waveforms, and determining the grain density based on the plurality of waveforms.

The method of any of the preceding clauses, wherein each of the plurality of waveforms defines a first peak and a second peak subsequent in time to the first peak such that the plurality of waveforms define a plurality of second peaks, and the method further includes determining the grain density based on a maximum of the plurality of second peaks.

The method of any of the preceding clauses, further including determining the grain density of the microstructure of the coating based on the waveform and a thickness of the coating.

The method of any of the preceding clauses, wherein the emitted electromagnetic signal is a plurality of electromagnetic pulses.

The method of any of the preceding clauses, wherein determining the grain density further includes determining a width of the waveform around the second peak, the width determined as a time interval from a first time at which the waveform exceeds an amplitude threshold prior to the second peak to a second time at which the waveform reaches the amplitude threshold after the second peak.

The method of any of the preceding clauses, wherein determining the grain density further includes dividing the width by a thickness of the coating to determine a normalized peak width and determining a grain density of the coating based on the normalized peak width.

The method of any of the preceding clauses, wherein the electromagnetic signal has a frequency in a range from 0.1 terahertz (THz) to 10 terahertz THz.

A system including an electromagnetic radiation emitter, an electromagnetic radiation detector, a polarizer, and a controller in communication with the electromagnetic radiation emitter and the electromagnetic radiation detector, the controller configured to emit an electromagnetic signal through the polarizer onto a coating of a component, the electromagnetic signal having a frequency of at least 0.1 gigahertz (GHz), receive a reflected electromagnetic signal from the coating, determine a waveform of the reflected electromagnetic signal, the waveform defining a plurality of peaks including a first peak and a second peak subsequent in time to the first peak, each of the plurality of peaks defined as a point where an amplitude of the waveform is greater than respective amplitudes of immediately adjacent points of the waveform and the amplitude is above an amplitude threshold, and determine a grain density of a microstructure of the coating based on the second peak of the waveform.

The system of any of the preceding clauses, further including a second polarizer, wherein the polarizer is rotatable by the controller to a first polarization angle of 0 degrees relative to a reference axis, and wherein the second polarizer is rotatable by the controller to a second polarization angle in a range from −90 degrees to 90 degrees relative to the first polarization angle.

The system of any of the preceding clauses, further including a second polarizer, wherein the polarizer is rotatable by the controller to a first polarization angle of 45 degrees relative to a reference axis, and wherein the second polarizer is rotatable by the controller to a second polarization angle in a range from −90 degrees to 90 degrees relative to the first polarization angle.

The system of any of the preceding clauses, wherein the controller is further configured to rotate the polarizer to a plurality of polarization angles, to emit a respective electromagnetic signal at each of the plurality of polarization angles, to receive a respective reflected electromagnetic signal from each respective emitted electromagnetic signal, to determine a respective waveform for each respective reflected electromagnetic signal to form a plurality of waveforms, and to determine the grain density based on the plurality of waveforms.

The system of any of the preceding clauses, wherein the electromagnetic signal has a frequency in a range from 0.1 terahertz (THz) to 10 THz.

The system of any of the preceding clauses, wherein the controller is further configured to determine the grain density of the microstructure of the coating based on the waveform and a thickness of the coating.

The system of any of the preceding clauses, wherein the controller is further configured to determine a width of the waveform around the second peak, the width determined as a time interval from a first time at which a first value of the waveform exceeds a second amplitude threshold prior to the second peak to a second time at which a second value of the waveform reaches the amplitude after the second peak.

The system of any of the preceding clauses, wherein the controller is further configured to divide the width by a thickness of the coating to determine a normalized peak width and to determine a number of grains per unit area of the coating based on the normalized peak width.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for determining a microstructure of a coating on a component, the method comprising:
emitting an electromagnetic signal through a polarizer onto the coating, the electromagnetic signal having a frequency of at least 0.1 gigahertz (GHz);
receiving a reflected electromagnetic signal from the coating;
determining a waveform of the reflected electromagnetic signal, the waveform defining a plurality of peaks including a first peak and a second peak subsequent in time to the first peak, each of the plurality of peaks defined as a point where an amplitude of the waveform is greater than respective amplitudes of immediately adjacent points of the waveform; and
determining a grain density of the microstructure of the coating based on the second peak of the waveform.

2. The method of claim 1, wherein the polarizer is a first polarizer, the first polarizer has a first polarization angle of 0 degrees relative to a reference axis, and wherein a second polarizer has a second polarization angle in a range from −90 degrees to 90 degrees relative to the first polarization angle.

3. The method of claim 1, wherein the polarizer is a first polarizer, the first polarizer has a first polarization angle of 45 degrees relative to a reference axis, and wherein a second polarizer has a second polarization angle in a range from −90 degrees to 90 degrees relative to the first polarization angle.

4. The method of claim 1, wherein the coating is one of a thermal barrier coating or an environmental barrier coating.

5. The method of claim 1, wherein the reflected electromagnetic signal is at least partially reflected from a bond coat disposed beneath the coating.

6. The method of claim 1, further comprising rotating the polarizer to a plurality of polarization angles, emitting a respective electromagnetic signal at each of the plurality of polarization angles, receiving a respective reflected electromagnetic signal from each respective emitted electromagnetic signal, determining a respective waveform for each respective reflected electromagnetic signal to form a plurality of waveforms, and determining the grain density based on the plurality of waveforms.

7. The method of claim 6, wherein each of the plurality of waveforms defines a first peak and a second peak subsequent in time to the first peak such that the plurality of waveforms define a plurality of second peaks, and the method further comprises determining the grain density based on a maximum of the plurality of second peaks.

8. The method of claim 1, further comprising determining the grain density of the microstructure of the coating based on the waveform and a thickness of the coating.

9. The method of claim 1, wherein the emitted electromagnetic signal is a plurality of electromagnetic pulses.

10. The method of claim 1, wherein determining the grain density further comprises determining a width of the waveform around the second peak, the width determined as a time interval from a first time at which the waveform exceeds an amplitude threshold prior to the second peak to a second time at which the waveform reaches the amplitude threshold after the second peak.

11. The method of claim 10, wherein determining the grain density further comprises dividing the width by a thickness of the coating to determine a normalized peak width and determining a grain density of the coating based on the normalized peak width.

12. The method of claim 1, wherein the electromagnetic signal has a frequency in a range from 0.1 terahertz (THz) to 10 THz.

13. A system comprising:
an electromagnetic radiation emitter;
an electromagnetic radiation detector;
a polarizer; and
a controller in communication with the electromagnetic radiation emitter and the electromagnetic radiation detector, the controller configured to:
emit an electromagnetic signal through the polarizer onto a coating of a component, the electromagnetic signal having a frequency of at least 0.1 gigahertz (GHz);
receive a reflected electromagnetic signal from the coating;
determine a waveform of the reflected electromagnetic signal, the waveform defining a plurality of peaks including a first peak and a second peak subsequent in time to the first peak, each of the plurality of peaks defined as a point where an amplitude of the waveform is greater than respective amplitudes of immediately adjacent points of the waveform and the amplitude is above an amplitude threshold; and
determine a grain density of a microstructure of the coating based on the second peak of the waveform.

14. The system of claim 13, further comprising a second polarizer, wherein the polarizer is rotatable by the controller to a first polarization angle of 0 degrees relative to a reference axis, and wherein the second polarizer is rotatable by the controller to a second polarization angle in a range from −90 degrees to 90 degrees relative to the first polarization angle.

15. The system of claim 13, further comprising a second polarizer, wherein the polarizer is rotatable by the controller to a first polarization angle of 45 degrees relative to a reference axis, and wherein the second polarizer is rotatable by the controller to a second polarization angle in a range from −90 degrees to 90 degrees relative to the first polarization angle.

16. The system of claim 13, wherein the controller is further configured to rotate the polarizer to a plurality of polarization angles, to emit a respective electromagnetic signal at each of the plurality of polarization angles, to receive a respective reflected electromagnetic signal from each respective emitted electromagnetic signal, to determine a respective waveform for each respective reflected electromagnetic signal to form a plurality of waveforms, and to determine the grain density based on the plurality of waveforms.

17. The system of claim 13, wherein the electromagnetic signal has a frequency in a range from 0.1 terahertz (THz) to 10 THz.

18. The system of claim 13, wherein the controller is further configured to determine the grain density of the microstructure of the coating based on the waveform and a thickness of the coating.

19. The system of claim 13, wherein the controller is further configured to determine a width of the waveform around the second peak, the width determined as a time interval from a first time at which a first value of the waveform exceeds a second amplitude threshold prior to the second peak to a second time at which a second value of the waveform reaches the amplitude after the second peak.

20. The system of claim 19, wherein the controller is further configured to divide the width by a thickness of the coating to determine a normalized peak width and to determine a number of grains per unit area of the coating based on the normalized peak width.
